(19) United States
(12) Patent Application Publication
(10) Pub. No.: US 2002/0163955 A1
(43) Pub. Date: Nov. 7, 2002

(54) Detachable probe mounting arrangement for an electronic clinical thermometer

(75) Inventor: Chu-Yih Yu, Hsien (TW)

Correspondence Address: DOUGHERTY & TROXELL, SUITE 1404, 5205 LEESBURG PIKE, FALLS CHURCH, VA, 22041, US

(73) Assignee: Mesure Technology Co., Ltd.

(21) Appl. No.: 09/836,194

(22) Filed: Apr. 18, 2001

(51) Int. Cl. G01K 1/14

(52) U.S. Cl. 374/208

(57) ABSTRACT

A detachable probe mounting arrangement includes a thermometer body, a probe, a coupling structure adapted to connect the probe to the thermometer body, the coupling structure comprising a fist connector fixedly provided at a front side of the thermometer body, a second connector fixedly provided at a rear side of the probe and adapted to connect said probe to the first connector, first contact means provided in the first connector, and second contact means provided in the second connector and adapted to contact the first contact means for transmitting temperature detection signal from the probe to the thermometer body for display on display means on the thermometer body. The connection between the first connector and the second connector can be achieved by a plug joint or screw joint.

### BACKGROUND OF THE INVENTION

The present invention relates to electronic thermometers and, more specifically, to a detachable probe mounting arrangement for an electronic thermometer.

A variety of mechanical and electronic thermometers have been disclosed, and have appeared on the market. A regular electronic thermometer is generally comprised of a thermometer body and a fixed probe protruded from the front side of the thermometer body. Because the probe is not detachable, it is practical to detect the temperature of a particular object, or a particular location of an object, i.e., the thermometer cannot fit different measuring requirements. Further, in order to eliminate contamination, a disposable probe-cover may be used and covered on the probe upon each use. The use of disposable probe-cover relatively increases the unit cost of every measuring operation.

### SUMMARY OF THE INVENTION

The present invention has been accomplished under the circumstances in view. It is the main object of the present invention to provide a detachable probe mounting arrangement, which enables the user to replace the probe conveniently subject to the kind (human being or animal) of the object to be measured. According one aspect of the present invention, the detachable probe mounting arrangement includes a thermometer body, a probe, a coupling structure adapted to connect the probe to the thermometer body, the coupling structure comprising a fist connector fixedly provided at a front side of the thermometer body, a second connector fixedly provided at a rear side of the probe and adapted to connect said probe to the first connector, first contact means provided in the first connector, and second contact means provided in the second connector and adapted to contact the first contact means for transmitting temperature detection signal from the probe to the thermometer body for display on display means on the thermometer body. According to another aspect of the present invention, the connection between the first connector and the second connector can be achieved by a plug joint or screw joint. Because the probe is detachably installed in the thermometer body, a set of probes can be selectively used with the thermometer body for different members of the family, for measuring different parts of the body, or for different measuring purposes. Because no disposable probe-cover is needed, the expense for disposable probe-cover is eliminated.

### BRIEF DESCRIPTION OF THE DRAWINGS

FIG. 1 is a top elevational view of the present invention.

FIG. 2 is a sectional view showing the arrangement of the coupling structure between the probe and the thermometer body according to the present invention.

FIG. 3 is an exploded view in an enlarged scale of the coupling structure shown in FIG. 2.

FIG. 4 is an exploded view of an alternate form of the coupling structure according to the present invention.

FIG. 5 is an exploded view of another alternate form of the coupling structure according to the present invention.

FIG. 6 is an exploded view of still another alternate form of the coupling structure according to the present invention.

FIG. 7 is an exploded view of still another alternate form of the coupling structure according to the present invention.

FIG. 8 illustrates the probe and the thermometer body arranged at right angles according to the present invention.

### DETAILED DESCRIPTION OF THE PREFERRED EMBODIMENT

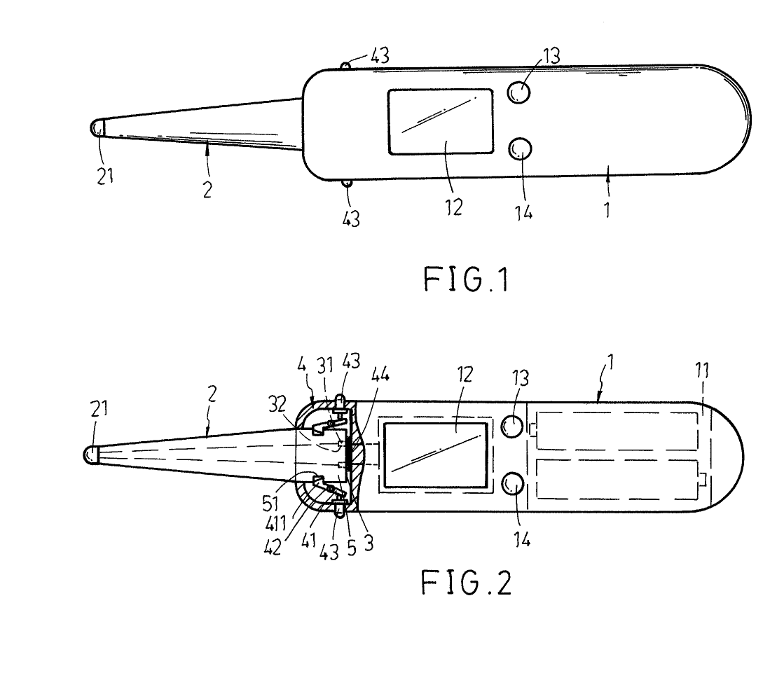

Referring to FIGS. 1 and 2, the invention comprises a thermometer body 1, and a probe 2. The thermometer body 1 comprises a battery chamber 11 holding a set of battery cells to provide the necessary working voltage, a LCD face panel 12 for the display of detection result, a selector button 13 for operation mode selection, and an on/off button 14 for on/off power control. The probe 2 comprises a sensor tip 21 disposed at the front side. The sensor tip 21 has an induction chip mounted on the inside and adapted to detect the temperature of the object to which the sensor tip 21 is attached. A coupling structure is provided between the thermometer body 1 and the probe 2, enabling the probe 2 can be detached from the thermometer body 1. Contact means 3 is provided in the coupling structure for enabling detected signal to be transmitted from the sensor tip 21 to the electric circuit of the thermometer body 1. The coupling structure may be variously embodied.

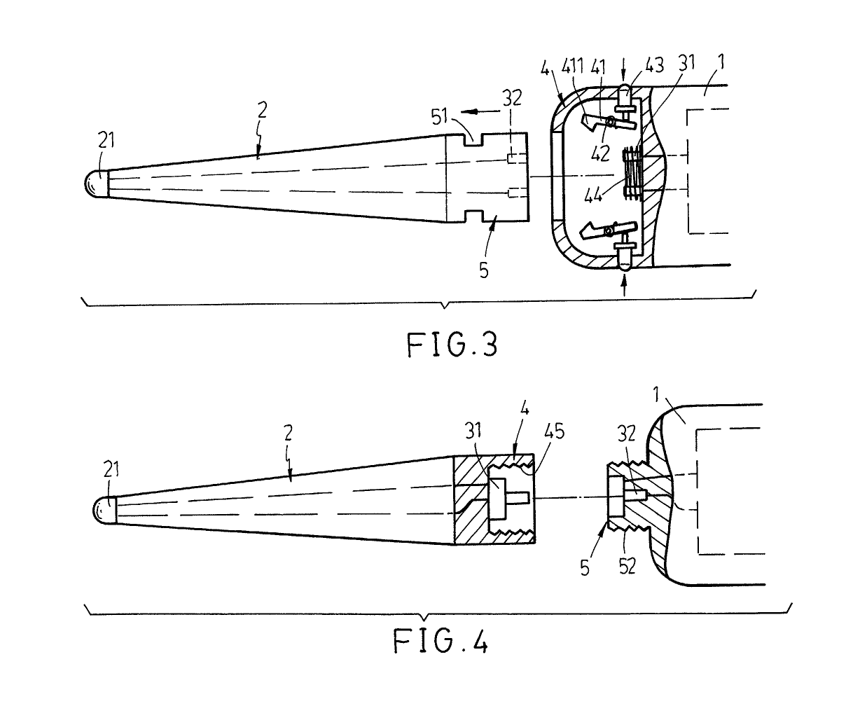

Referring to FIG. 3 and FIG. 2 again, the coupling structure comprises a female connector 4 fixedly provided at the front side of the thermometer body 1, and a male connector 5 fixedly provided at the rear side of the probe 2 for connection to the female connector 4. The female connector 4 comprises a compression spring 44 axially disposed at the center, two pivoted hooks 41 disposed at two sides of the compression spring 44 and turned between the locking position and the unlocking position, two torsional springs 42 respectively mounted on the hooks 41 to hold the hooks in the locking position, and two control buttons 43 for pressing by hand to turn the hooks from the locking position to the unlocking position. The male connector 5 comprises an annular locating groove 51 around the periphery. When inserting the male connector 5 with the probe 2 into the female connector 4 at the rear side of the thermometer body 1, the hooks 41 are forced outwards by the male connector 5 and then immediately forced back by the respective torsional springs 42 and forced into engagement with the locating groove 51 to lock the probe 2. The contact means 3 comprises first contacts 31 mounted in the female connector 4, and second contacts 32 mounted in the male connector 5 and electrically connected to the induction chip of the sensor tip 21 by conductors. After installation of the probe 2 in the thermometer body 1, the second contacts 32 are maintained in contact with the first contacts 31 respectively, enabling the detected signal to be transmitted from the sensor tip 21 of the probe 2 to the electric circuit of the thermometer body 1 and displayed on the LCD face panel 12.

Referring to FIG. 3 again, when pressing the control buttons 43 with the fingers to turn the hooks 41 from the locking position to the unlocking position, the compression spring 44 is released from the constraint to push the male connector 5 out of the female connector 4.

FIG. 4 shows an alternate form of the coupling structure. According to this embodiment, the male connector 5 is fixedly provided at the front side of the thermometer body 1, and the female connector 4 is fixedly provided at the rear side of the probe 2. The male connector comprises an outer thread 52 around the periphery. The female connector 4 comprises an inner thread 45 for threading onto the outer thread 52 of the male connector 5.

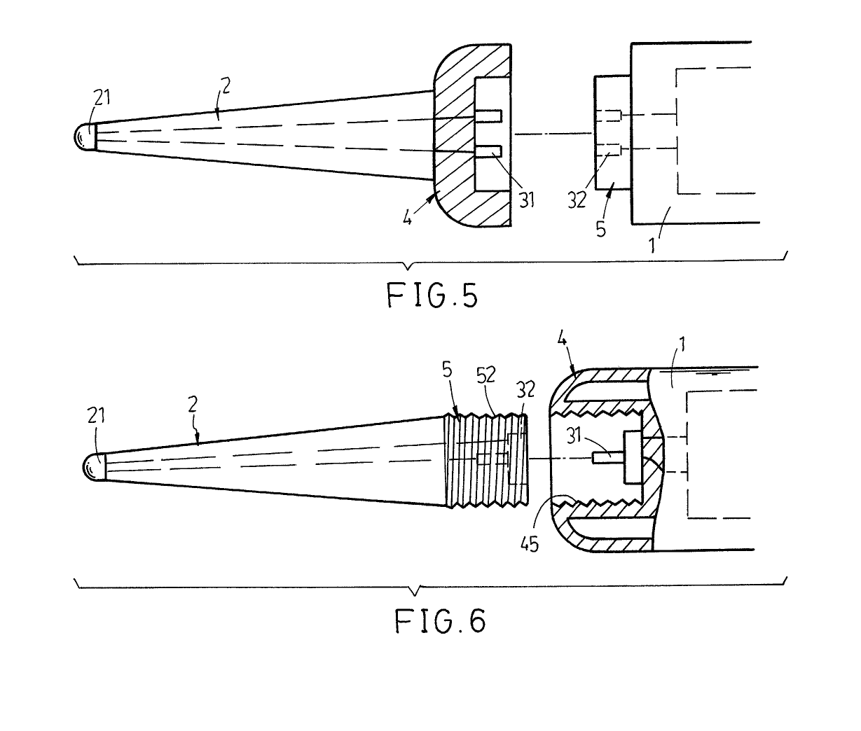

FIG. 5 shows another alternate form of the coupling structure. According to this embodiment, the female connector 4 is fixedly provided at the rear side of the probe 2, and the male connector 5 is fixedly provided at the front side of the thermometer body 1 and adapted to be press-fitted into the female connector 4.

FIG. 6 shows still another alternate form of the coupling structure. According to this embodiment, the female connector 4 has an inner thread 45 and is fixedly provided at the front side of the thermometer body 1, and the male connector 5 has an outer thread 52 and is fixedly provided at the rear side of the probe 2 for threading into the inner thread 45 of the female connector 4.

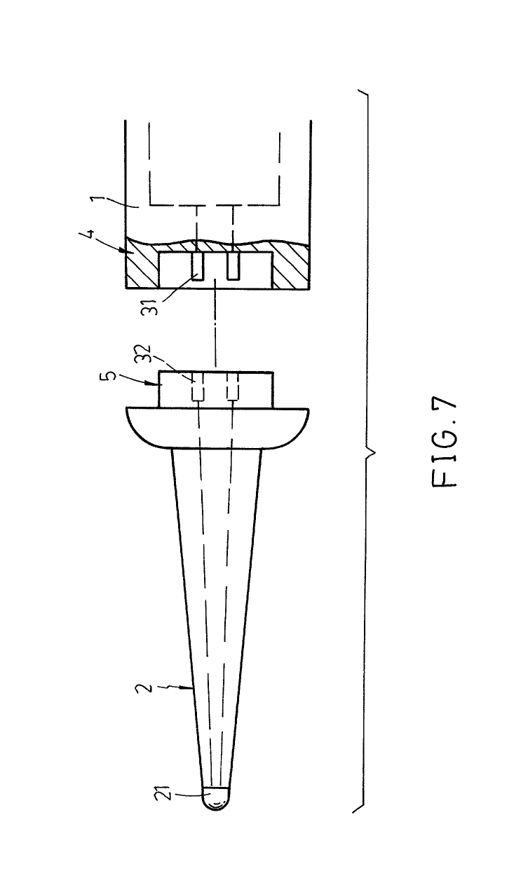

FIG. 7 shows still another alternate form of the coupling structure. According to this embodiment, the female connector 4 is fixedly provided at the front side of the thermometer body 1, and the male connector 5 is fixedly provided at the rear side of the probe 2 and adapted to be press-fitted into the female connector 4.

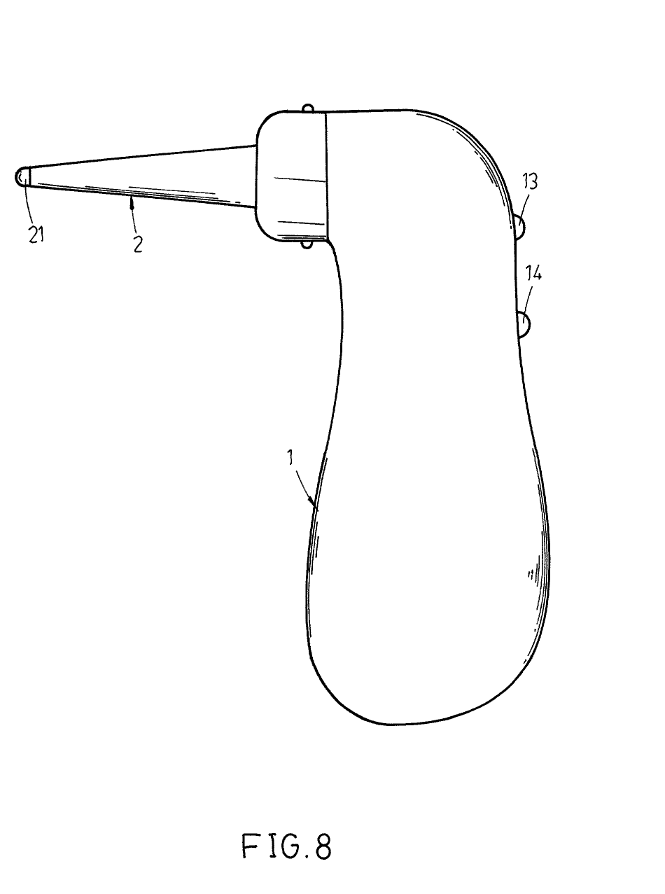

The thermometer body 1 can be made having any of a variety of shapes. In FIG. 1, the thermometer body 1 and the probe 2 are axially aligned in a line. In FIG. 8, the thermometer body 1 and the probe 2 are arranged at right angles.

A prototype of detachable probe mounting arrangement has been constructed with the features of FIGS. 18. The detachable probe mounting arrangement functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A detachable probe mounting arrangement comprising a thermometer body, a probe, a coupling structure adapted to connect said probe to said thermometer body, said coupling structure comprising a fist connector fixedly provided at a front side of said thermometer body, a second connector fixedly provided at a rear side of said probe and adapted to connect said probe to said first connector, first contact means provided in said first connector, and second contact means provided in said second connector and adapted to contact said first contact means for transmitting temperature detection signal from said probe to said thermometer body for display on display means on said thermometer body.

2. The detachable probe mounting arrangement of claim 1 wherein said first connector is a male connector, and said second connector is a female connector adapted to connect said male connector by a plug joint.

3. The detachable probe mounting arrangement of claim 1 wherein said first connector is a female connector, and said second connector is a male connector adapted to connect said female connector by a plug joint.

4. The detachable probe mounting arrangement of claim 1 wherein said first connector is a male connector, and said second connector is a female connector adapted to connect said male connector by a screw joint.

5. The detachable probe mounting arrangement of claim 1 wherein said first connector is a female connector, and said second connector is a male connector adapted to connect said female connector by a screw joint.
